(19) United States
(12) Patent Application Publication
(10) Pub. No.: US 2026/0164349 A1
(43) Pub. Date: Jun. 11, 2026

(54) DYNAMIC POWER SAVE FOR UHR MOBILE-AP

(71) Applicant: APPLE INC., Cupertino, CA (US)

(72) Inventors: Neelakantan Nurani Krishnan, San Diego, CA (US); Jarkko L. Kneckt, Los Gatos, CA (US); Anuj Batra, Redwood City, CA (US); Minyoung Park, Sunnyvale, CA (US); Yong Ho Seok, Cupertino, CA (US); Chittabrata Ghosh, Fremont, CA (US); Yong Liu, Campbell, CA (US)

(21) Appl. No.: 19/341,689

(22) Filed: Sep. 26, 2025

Related U.S. Application Data
(60) Provisional application No. 63/728,282, filed on Dec. 5, 2024.

(51) Int. Cl. H04W 52/02; H04W 4/06

(52) U.S. Cl. CPC H04W 52/0206; H04W 4/06; H04W 52/0219

(57) ABSTRACT

Embodiments herein provide mechanisms by which a Mobile Access Point (mobile-AP) may communicate information pertaining to Dynamic Power Save (DPS) operation to non-AP stations (STAs). A mobile-AP may generate a frame comprising DPS operating parameters, and send the frame to one or more non-AP STAs. The mobile-AP and the STA may use the DPS operating parameters for DPS operations.

### TECHNICAL FIELD

This application generally relates to wireless communication systems, including signaling of dynamic power save related information to non-Access Point stations.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. For example, Simultaneous Authentication of Equals is the core authentication protocol of WPA3-Personal, and is mandated to be supported by all Wi-Fi® Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example transmission timeline for a non-AP STA and a mobile-AP employing a dynamic power save (DPS) lower-capability (LC) mode and a DPS higher-capability (HC) mode, in accordance with some embodiments.

FIG. 2 illustrates an example capability information field that may be included in a broadcast frame, in accordance with some embodiments.

FIG. 3 illustrates an example UHR operation element, in accordance with some embodiments.

FIG. 4 illustrates an example DPS Operation IE, in accordance with some embodiments.

FIG. 5 illustrates an example beacon transmission timeline, in accordance with some embodiments.

FIG. 6 illustrates an example transmission timeline for unicast signaling of DPS attributes by a mobile-AP, in accordance with some embodiments.

FIG. 7 illustrates a method for a mobile-AP, according to embodiments herein.

FIG. 8 illustrates a method for a non-AP STA, according to embodiments herein.

FIG. 9 illustrates an example of a system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is Institute of Electrical and Electronics Engineers (IEEE) 802.11 standard for Wireless Local Area Networks (WLAN) (commonly known to industry groups as Wi-Fi®). Wi-Fi® provides a convenient way to establish a network between devices. A device (e.g., a station) may connect to a Wi-Fi® access point to join a network and connect to the internet wirelessly.

An Access Point (AP) is a device that creates a wireless local area network (WLAN), or Wi-Fi® network. A station (STA) is a device that is capable of being wirelessly connected to the AP to join the network. A mobile-AP is a device that can function as a portable AP to provide internet access to nearby STAs. For example, a mobile-AP may be a cellular phone with hotspot mode enabled.

Various embodiments are described with regard to a (STA) and Access Point (AP). However, reference to a STA and AP is merely provided for illustrative purposes. The example embodiments may be utilized with any electronic component that may establish a connection to a network and is configured with the hardware, software, and/or firmware to exchange information and data with the network. Therefore, the STAs and Aps, as described herein, are used to represent any appropriate electronic component.

One of the goals of Wi-Fi® is to minimize power consumption of devices. Minimizing power consumption in Wi-Fi® devices (especially mobile-APs) is important, due to the demanding power requirements associated with their operation. Acting as an AP may involve continuous data transmission, signal processing, and frequent communication with multiple devices, all of which can heavily drain power. For mobile-APs (which are often battery-operated), this increased power usage can significantly reduce battery life and the operational time of the device. Effective power management, including dynamic power save operation, can extend battery life. By reducing power consumption, mobile-APs can remain active for longer periods without frequent recharging, supporting their role as convenient, portable network hubs. Embodiments herein relate to DPS operation for a mobile-AP. Specifically, some embodiments describe how a mobile-AP may communicate DPS-related information to non-AP STA(s).

In some wireless systems, a dynamic power save operation may include a power save mode and a non-power save mode. A power save mode may be used to enable energy-efficient operation. Power save modes may be useful in reducing the power consumption for battery-operated mobile-APs, as they can help conserve energy by allowing the mobile-AP to enter low-power states during idle periods, or when minimal data transmission is required. In some embodiments, a power save mode may be referred as a lower-capability mode, and a non-power save mode may be referred to as a higher-capability mode.

A power save mode may be defined for a STA that is an Ultra-High Reliability (UHR) mobile-AP or a UHR non-AP STA. In some embodiments, the STA (e.g., mobile-AP or non-AP STA) may transition from a lower-capability mode to a higher-capability mode upon reception of an initial control frame (ICF). The power management technique that allows a device to dynamically adjust between the lower-capability mode and the higher-capability mode may be referred to as a DPS operation.

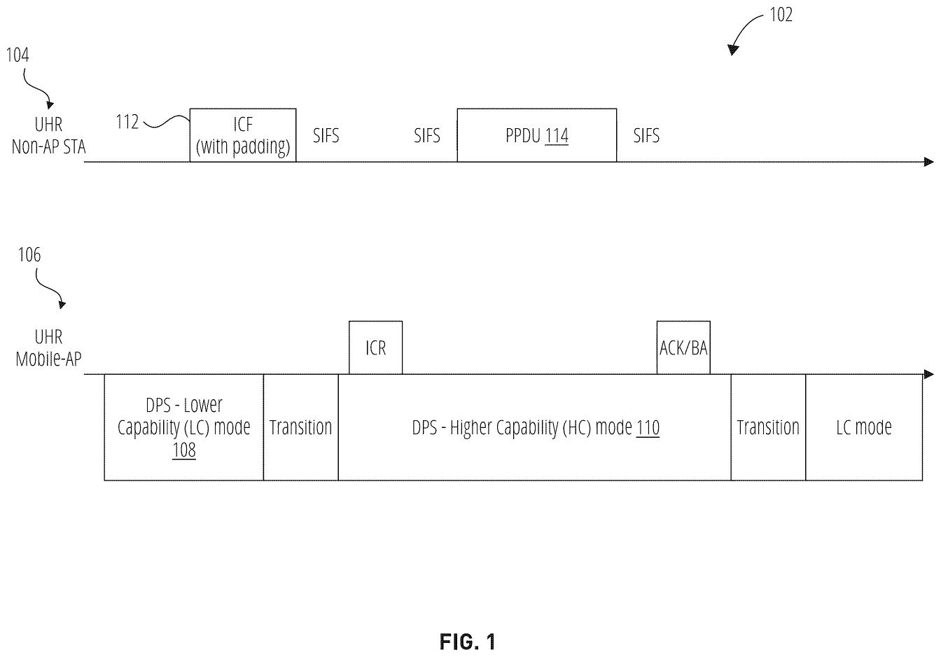

For example, FIG. 1 illustrates an example transmission timeline 102 for a non-AP STA 104 and a mobile-AP 106 employing a dynamic power save (DPS) lower-capability (LC) mode and a DPS higher-capability (HC) mode, in accordance with some embodiments. The mobile-AP 106 may leverage dynamic power save operation to reduce power consumption.

For example, when idle during idle periods, or when minimal data transmission is performed, the mobile-AP 106 may use LC mode 108. LC mode 108 may be characterized by reduced capabilities relative to an HC mode 110. For example, the LC mode 108 may have reduced capabilities in terms of one or more of operating channel bandwidth, the number of spatial streams supported, the maximum data rate that the device can receive while operating in that mode, and the various Physical layer Protocol Data Unit (PPDUs) that the device can receive in that mode. For example, in some embodiments, when the mobile-AP 106 is operating in the LC mode 108, the mobile-AP 106 may support an operating channel bandwidth of 20 MHz, one spatial stream, limited data rates, and non-HT (duplicate) PPDU formats. Because of the reduced capabilities, the mobile-AP 106 may use less power when in LC mode 108 than when it is in HC mode 110.

When the non-AP STA 104 or some peer device wants to initiate frame exchanges with the mobile-AP 106 operating in LC mode 108, the non-AP STA 104 may send an ICF 112 with sufficient padding. In some embodiments, the ICF 112 may be a Multi-User Request to Send (MU-RTS) or a Buffer Status Report Poll (BSRP). The ICF 112 may indicate that the mobile-AP 106 should transition from the LC mode 108 to the HC mode 110.

The mobile-AP 106 may transition to the HC mode 110 to participate in a subsequent frame exchange with the initiating device (e.g., non-AP STA 104). The non-AP STA 104 may send the PPDU 114, and the mobile-AP 106 may receive the PPDU 114 in HC mode 110. Once the frame exchange ends, the mobile-AP 106 may be free to transition back into LC mode and continue listening to the medium for another ICF using the lower capabilities.

Embodiments herein describe how a mobile-AP may communicate DPS-related information to non-AP STA(s). The DPS-related information communicated to a non-AP STA may include a current DPS state of the mobile-AP (e.g., Enabled/Disabled). If DPS is currently enabled, then the mobile-AP 106 may also communicate the DPS Padding Delay and DPS Transition Delay. The DPS-related information communicated to a non-AP STA may include information regarding a planned DPS mode change in the future, if any. If DPS will be enabled, the DPS-related information communicated to a non-AP STA may include updates to DPS Padding Duration and the DPS Transition Delay (e.g., the delay between the transition between the HC mode and the LC mode), if any.

There may be two variants of signaling of DPS information from mobile-AP to Non-AP STA(s) that may be used. Some embodiments may use broadcast signaling to send the DPS information to all STAs in one shot. For example, the broadcast signaling may be included in Beacon, (unsolicited or solicited) Probe Response, or fast initial link setup (FILS) discovery frames. Some embodiments may use unicast signaling to send the DPS information to each STA individually. For example, the unicast signaling may be included in an Association Response frame or a new action frame. Some embodiments may use both broadcast signaling and unicast signaling.

Broadcast Signaling of DPS Attributes by mobile-AP may allow a mobile-AP to send the information to multiple STAs at once. A UHR mobile-AP can indicate a current DPS state and mode change (if planned) in a Beacon, Probe Response, or FILS Discovery frame(s). The UHR mobile-AP may specify various information related to the DPS in the broadcast signaling (e.g., current DPS state, planned DPS mode change, DPS Padding Duration, DPS transition delay, etc.).

To indicate whether a current DPS state is enabled or disabled, the mobile-AP may use a DPS enabled bit in a new UHR element (e.g., UHR Operation element). If DPS is currently enabled, then the mobile-AP may specify DPS Padding Duration and DPS Transition Delay in a new UHR element (e.g., UHR Operation element). These attributes may describe a current DPS operation of a mobile-AP. In some embodiments, the mobile-AP may indicate a future DPS mode change by including a new element called DPS Operation information element (IE) in the broadcast signaling.

For power savings, a non-AP STA may not always receive and process a full broadcast frame Instead, the STA may inspect only part of the broadcast frame and may terminate the reception early if certain conditions are met. To prevent the STA from terminating reception of the broadcast frame early when it includes DPS information, the mobile-AP may include a critical update flag in the broadcast frame. The critical update flag may notify the non-AP STA that a critical piece of information is being carried in the broadcast frame.

In some embodiments, the following events may be classified as a critical update. In some embodiments, a new flag may be defined called a UHR Critical Updated flag. The UHR Critical Updated flag may identify a DPS update as a UHR critical update, since such updates are irrelevant for pre-UHR STAs. A new UHR-specific flag may be defined to indicate to the UHR non-AP STA(s) DPS-specific updates from the mobile-AP. For pre-UHR non-AP STA(s), such updates are irrelevant, and they need not be forced to receive this information. The UHR Critical Update flag may be set to 1 and Beacon Preamble Counter Control (BPCC) incremented for the updates. In some embodiments, a modification of UHR Operation element may be a UHR critical update. In some embodiments, inclusion of DPS Operation IE in the beacon or probe response frames may be a UHR critical update. Accordingly, the mobile-AP may use the UHR critical update field to indicate to the STAs to receive the remainder of a broadcast frame when there is updated to the DPS attributes.

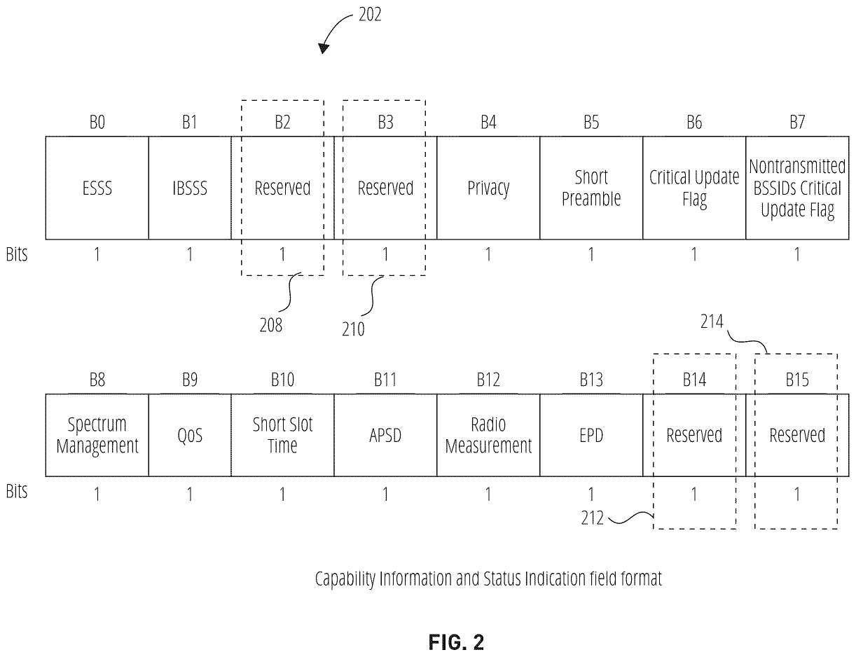

FIG. 2 illustrates an example Capability Information and Status Indication field format 202 that may be included in a broadcast frame (e.g., beacon, probe, or FILS Discovery frame), in accordance with some embodiments. The Capability Information and Status Indication field format 202 may include a UHR critical update flag. In some embodiments, the mobile-AP may set the UHR critical update flag to one to indicate to STAs that there is a modification of a UHR operation element in the broadcast frame, or that the broadcast frame includes a DPS operation IE. It may be desirable to explicitly identify a DPS update as UHR Critical Update, since such updates are irrelevant for pre-UHR STAs. In some embodiments, the UHR Critical Update may be indicated using one of the reserved bits in Capability Information and Status Indication field (e.g., B2 208, B3 210, B14 212, or B15 214)

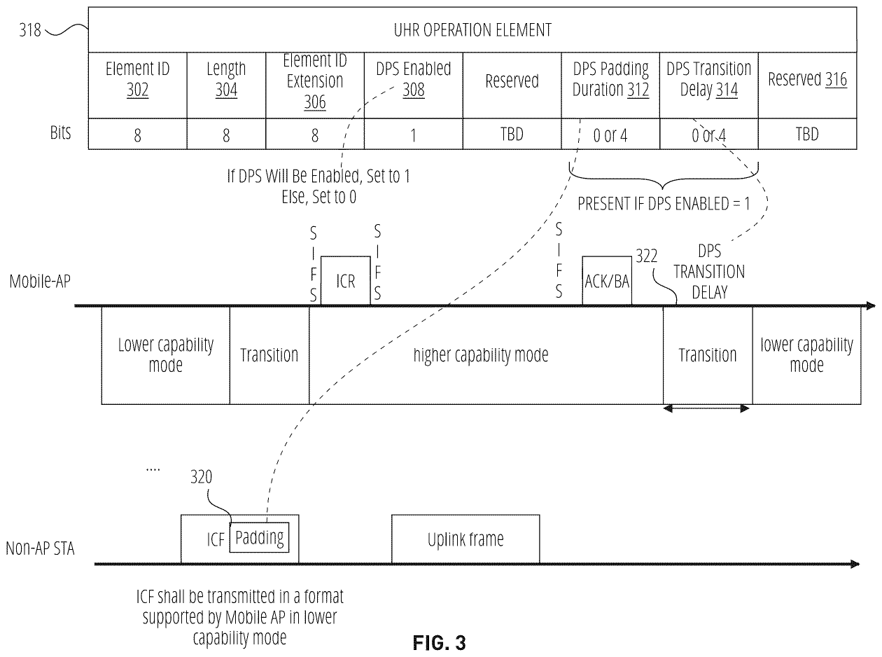

FIG. 3 illustrates an example UHR operation element 318, in accordance with some embodiments. As shown, the UHR operation element 318 may include an element ID 302, a length field 304, an element ID extension 306, a DPS enabled field 308, a parameter update control field 310, a DPS padding duration field 312, a DPS transition delay field 314, and a Reserved 316. The element ID 302 may identify the IE as a UHR operation element. The length field 304 may specify the number of bytes used in the UHR operation element 318. The element ID extension 306 may be used to extend the range of the element ID 302.

The DPS enabled field 308 may indicate whether or not DPS is currently enabled. In some embodiments, if the DPS is currently enabled the DPS enabled field 308 is set to one, otherwise the DPS enabled field 308 is set to zero. The mobile-AP may use the DPS enabled field 308 to signal to the STAs the status of DPS enablement.

The DPS padding duration field 312 may indicate the padding duration that the STAs should apply for an ICF. This padding may provide sufficient time for the mobile-AP to transition for the LC mode to the HC mode. In some embodiments, the ICF may be transmitted in non-HT duplicate format with a max data rate of 24 Mbps. As shown, the STA may send an ICF with padding 320. The DPS padding duration field 312 indicates the duration of the padding 320. In some embodiments, the DPS padding duration field 312 may be zero bits or four bits. In some embodiments the DPS padding duration field 312 is only present if DPS enabled field 308 is set to one.

The DPS transition delay field 314 may indicate the time delay of the transition 322 between DPS modes. The DPS transition delay in the DPS transition delay field 314 may refer to the time delay that the STAs wait before initiating the next frame exchange with the mobile-AP because this time is used to transition from the HC mode to the LC mode. In some embodiments, the DPS transition delay field 314 is only present if DPS enabled field 308 is set to one.

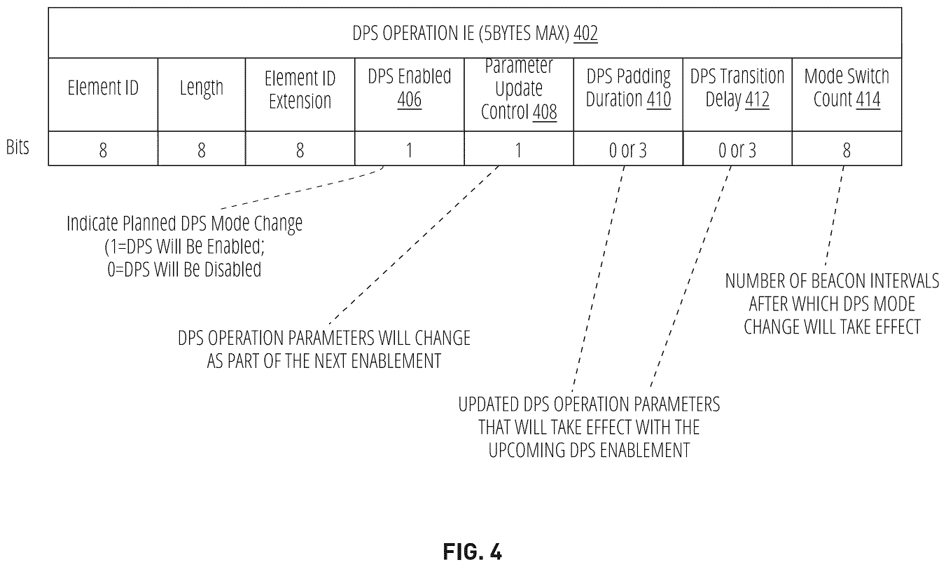

FIG. 4 illustrates an example DPS Operation IE 402, in accordance with some embodiments. The DPS enabled field 406 may indicate a planned DPS mode change. In some embodiments, if the DPS will be enabled the DPS enabled field 406 is set to one, the DPS enabled field 406 is set to zero to indicate that DPS will be disabled.

The parameter update control field 408 may indicate whether DPS operation parameters (e.g., DPS padding duration and DPS transition delay) will change as part of the next enablement. In some embodiments, the mobile-AP may set the parameter update control field 408 to one to indicate to the STAs that there will be a change as part of the next enablement to at least one of the DPS padding duration 410, DPS transition delay 412.

The DPS padding duration 410 and the DPS transition delay 412 may indicate updated DPS operation parameters that will take effect with the upcoming DPS enablement. The mode switch count 414 may indicate the number of Beacon intervals after which DPS mode change will take effect, This mode switch count 414 may provide timing information for the state change (e.g., when DPS is enabled) because the mobile-AP may be free to enable or disable the DPS in the future. The mode switch count 414 may allow the mobile-AP to communicate that timing information with sufficient notice to the non-AP STAs so that they can prepare for this change accordingly.

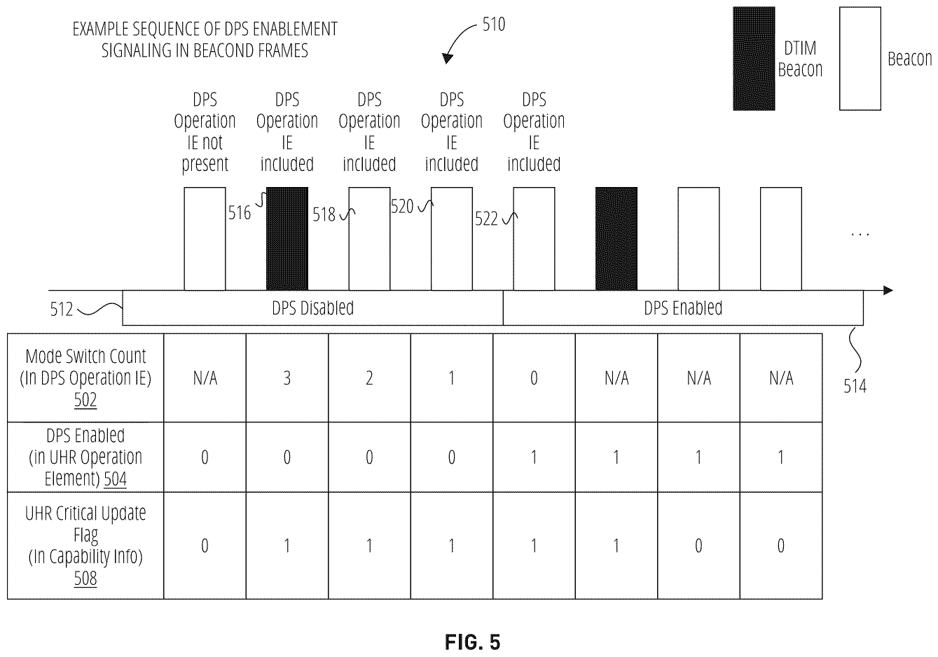

FIG. 5 illustrates an example beacon transmission timeline 510, in accordance with some embodiments. In the illustrated embodiment, the mobile-AP initially has disabled its DPS mode (e.g., DPS disabled 512). At some point the mobile-AP may want to enable DPS (e.g., DPS enabled 514). To enable DPS, the mobile-AP may include the DPS operation IE (e.g., UHR operation element 318 of FIG. 3) in a first beacon 516. The DPS operation IE may include a mode switch count 502 that specifies the number of beacon intervals after which DPS will be enabled.

In the illustrated example, the mode switch count 502 is set to be three in the first beacon 516, which means that after three beacon intervals DPS will be enabled. In a second beacon 518, the mode switch count 502 with the DPS operation IE decrements from three to two. The third beacon 520 with the mode switch count 502 again decrements the mode switch count 502 from two to one, and in the fourth beacon 522 the mode switch count 502 reaches zero. When the mode switch count 502 reaches zero, from that beacon on the DPS mode change (e.g., DPS Enabled bit 504) takes effect.

Additionally, the beacons that include DPS operation IE may include a UHR critical update flag 508. The UHR critical update flag 508 may indicate that the broadcast frame includes a DPS operation IE. As shown, at the first beacon 516, the UHR critical update flag 508 may be set to one. The UHR critical update flag 508 may remain at one, until the DPS IE is not included in the beacon.

Within the UHR operation element, when DPS is disabled, the DPS Enabled bit 504 is set to zero indicating that the mobile-AP has not enabled DPS. When DPS is enabled the mobile-AP sets the DPS Enabled bit 504 to one. This bit may remain at one until DPS is disabled. In the illustrated embodiment, the DPS Enabled bit 504 is referring to a bit in the UHR operation element and not the DPS enabled bit in the DPS operation IE. The DPS Enabled bit 504 in the UHR operation element and the DPS enabled bit in the DPS operation IE represent two different things. The DPS operation IE provides information for the DPS mode planned for the future, whereas the DPS in the UHR operation element describes the operation that is currently happening. Which is why DPS Enabled bit 504 is zero when DPS is disabled by the mobile-AP and gets set to one when DPS is enabled by the mobile-AP.

In some embodiments, a mobile-AP may use unicast signaling to send DPS attributes to a non-AP STA. There may be two variants of unicast signaling. A first variant may be signaling in an Association Response frame. A second variant may be signaling in an Action frame (e.g., a new protected Action frame) post association.

A Mobile-AP may indicate DPS parameters to an unassociated UHR STA in the Association Response frame. Accordingly, the mobile-AP may indicate various DPS attributes to an unassociated STA at the time of association. For example, if the mobile-AP has already enabled DPS and a new unassociated UHR STA tries to associate the mobile-AP, it may be helpful for the mobile-AP to communicate that DPS is currently enabled and also the various attributes like transition delay, DPS padding, etc.

The Association Response may indicate a current DPS state (e.g., enabled or disabled). For example, the Association Response may use a DPS enabled bit in a new UHR element (e.g., UHR Operation element) to signal the current DPS state. This may allow the STA to be fully aware of the current DPS mode of operation of the mobile-AP. Such DPS information may be used by the STA to decide whether or not to join the mobile-AP. If DPS is currently enabled, the Association Response may specify DPS parameters (e.g., DPS Padding Duration, DPS Transition Delay, etc.) in a new UHR element (e.g., UHR Operation element). In some embodiments, the Association response may indicate a future DPS mode change by including the DPS Operation IE.

In some embodiments, if a mobile-AP wishes to change DPS mode in the future (post association) and there are only a few STAs (e.g., one or two) associated with it, then the mobile-AP may indicate the DPS mode change using unicast signaling to each STA. The benefits to unicast signaling may include a quicker mode change possible at the mobile-AP instead of waiting for Beacon period(s) which may lead to power consumption savings. The unicast signaling may also be more reliable than broadcast signaling. In broadcast signaling there are no ACK responses like is found in unicast signaling. Accordingly, when using broadcast signaling the mobile-AP may not have a way to determine whether all the STAs have received the DPS information. In some embodiments, both unicast and broadcast are allowed. This may provide flexibility in signaling the DPS information.

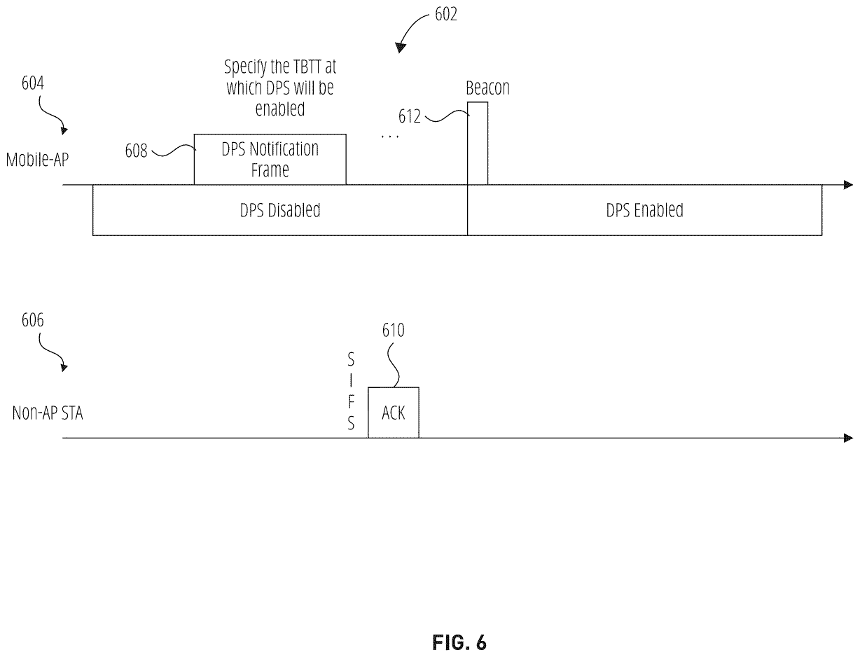

FIG. 6 illustrates an example transmission timeline 602 for unicast signaling of DPS attributes by a mobile-AP 604, in accordance with some embodiments. The mobile-AP 604 may have DPS disabled. As shown, the mobile-AP 604 may send a unicast protected action frame (with ACK) called DPS notification frame 608 to notify non-AP STA 606 about a DPS mode change (e.g., DPS disabled to DPS enabled).

The mobile-AP 604 may include a DPS Operation IE in the DPS notification frame 608. The mobile-AP 604 may use the DPS notification frame 608 and DPS operation IE to specify the target beacon transmission time (TBTT) at which DPS state change will take effect using the mode switch count field in the DPS operation IE. For example, the mobile-AP 604 may indicate that it is switching to DPS enabled at beacon 612.

The non-AP STA 606 may respond to the DPS notification frame 608 with an ACK 610. When the mobile-AP 604 receives the ACK 610, the mobile-AP 604 knows that the non-AP STA 606 that the non-AP STA 606 is aware of the upcoming DPS mode change. The mobile-AP 604 may enable DPS at the beacon 612 indicated in the DPS notification frame 608.

Embodiments herein provide mechanisms by which a UHR Mobile-AP may communicate information pertaining to dynamic power save operation to UHR non-AP STAs. A mobile-AP may use one or both of broadcast signaling and unicast signaling to send a STA DPS Attributes. Broadcast signaling from Mobile-AP may use a Beacon frame, a Probe Response frame, and/or a FILS discovery frame. Unicast signaling from the Mobile-AP to each STA may use an Association Response frame and/or a new protected Action frame called DPS Notification frame.

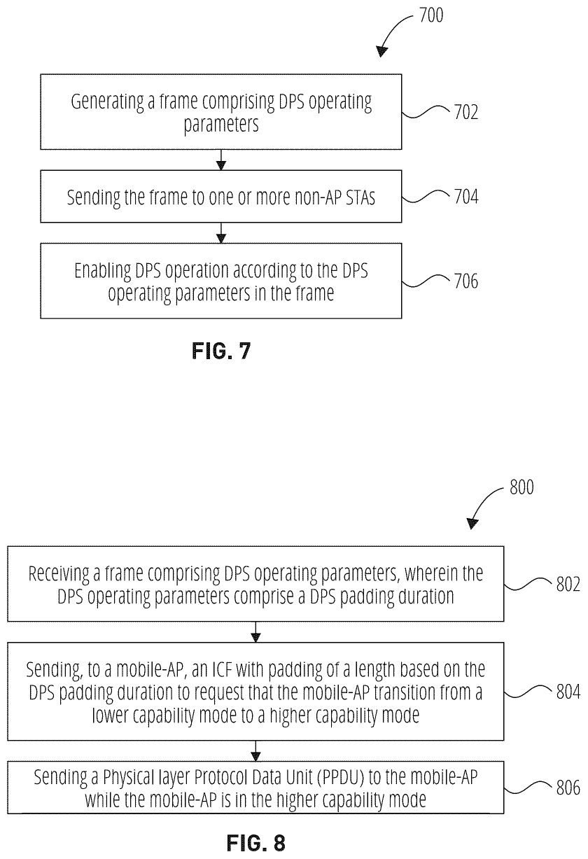

FIG. 7 illustrates a method 700 for a mobile-AP, according to embodiments herein. The illustrated method 700 includes generating 702 a frame comprising DPS operating parameters. The method 700 further includes sending 704 the frame to one or more non-AP STAs. The method 700 further includes enabling 706, DPS operation according to the DPS operating parameters in the frame.

In some embodiments of the method 700, the frame comprises a DPS operation IE comprising a DPS enabled field that indicates if DPS will be enabled, and a mode switch count TBTT at which a DPS state change will take effect.

In some embodiments of the method 700, the DPS operating parameters comprise an DPS Padding Duration and a DPS transition delay.

In some embodiments of the method 700, the frame with the DPS operating parameters is sent using broadcast signaling. In some such embodiments, the broadcast signaling comprises a beacon frame, a probe response frame, or a FILS discovery frame. Some other such embodiments further comprise setting a UHR critical update flag in a capability information field of the broadcast signaling when there is a modification of a DPS operating parameters or when a DPS operation IE is included in the broadcast signaling.

In some embodiments of the method 700, the frame with the DPS operating parameters is sent using unicast signaling. In some such embodiments, the unicast signaling comprises an Association Response frame or a DPS Notification Frame.

Embodiments contemplated herein include an apparatus comprising means to perform one or more elements of the method 700. This apparatus may be, for example, an apparatus of an AP (such as an AP 918, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of an AP (such as a memory 922 of an AP 918, as described herein).

Embodiments contemplated herein include an apparatus comprising logic, modules, or circuitry to perform one or more elements of the method 700. This apparatus may be, for example, an apparatus of an AP (such as an AP 918, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of an AP (such as an AP 918, as described herein).

Embodiments contemplated herein include a signal as described in, or related to, one or more elements of the method 700.

Embodiments contemplated herein include a computer program or computer program product comprising instructions, wherein execution of the program by a processing element is to cause the processing element to carry out one or more elements of the method 700. The processor may be a processor of an AP (such as a processor(s) 920 of an AP 918, as described herein). These instructions may be, for example, located in the processor and/or on a memory of the AP (such as a memory 922 of an AP 918, as described herein).

FIG. 8 illustrates a method 800 for a non-AP STA, according to embodiments herein. The illustrated method 800 includes receiving 802 a frame comprising DPS operating parameters, wherein the DPS operating parameters comprise an DPS Padding Duration. The method 800 further includes sending 804, to a mobile-AP, an ICF with padding of a length based on the DPS Padding Duration to request that the mobile-AP transition from a lower-capability mode to a higher-capability mode. The method 800 further includes sending 806 a PPDU to the mobile-AP while the mobile-AP is in the higher-capability mode.

In some embodiments of the method 800, the frame comprises a DPS operation IE comprising a DPS enabled field that indicates if DPS will be enabled, and a mode switch count TBTT at which a DPS state change will take effect.

In some embodiments of the method 800, the DPS operating parameters further comprise a DPS transition delay.

In some embodiments of the method 800, the frame with the DPS operating parameters is received in broadcast signaling. In some such embodiments, the broadcast signaling comprises a beacon frame, a probe response frame, or a FILS discovery frame. Some other such embodiments further comprise detecting a UHR critical update flag in a capability information field of the broadcast signaling indicating that there is a modification of a DPS operating parameters or that a DPS operation IE is included in the broadcast signaling.

In some embodiments of the method 800, the frame with the DPS operating parameters is received in unicast signaling. In some such embodiments, the unicast signaling comprises an Association Response frame or a DPS Notification Frame.

Embodiments contemplated herein include an apparatus comprising means to perform one or more elements of the method 800. This apparatus may be, for example, an apparatus of a STA (such as STA 902 as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a STA (such as a memory 906 of an STA 902, as described herein).

Embodiments contemplated herein include an apparatus comprising logic, modules, or circuitry to perform one or more elements of the method 800. This apparatus may be, for example, an apparatus of a STA (such as an STA 902, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a STA (such as an STA 902, as described herein).

Embodiments contemplated herein include a signal as described in, or related to, one or more elements of the method 800.

Embodiments contemplated herein include a computer program or computer program product comprising instructions, wherein execution of the program by a processor is to cause the processor to carry out one or more elements of the method 800. The processor may be a processor of a STA (such as a processor(s) 904 of an STA 902, as described herein). These instructions may be, for example, located in the processor and/or on a memory of the STA (such as a memory 906 of an STA 902, as described herein).

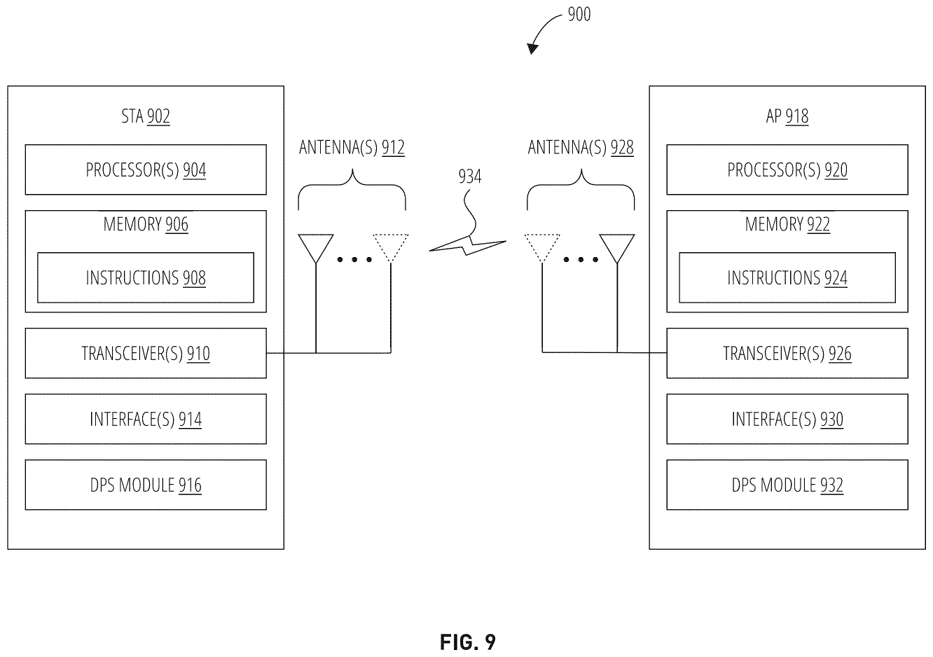

FIG. 9 illustrates a system 900 for performing signaling 934 between an STA 902 and an AP 918, according to embodiments disclosed herein. The system 900 may be a portion of a wireless communications system as herein described. The STA 902 may be, for example, a UE of a wireless communication system. The AP 918 may be, for example, an access point of a wireless communication system.

The STA 902 may include one or more processor(s) 904. The processor(s) 904 may execute instructions such that various operations of the STA 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The STA 902 may include one or more transceiver(s) 910 that may include radio frequency (RF) transmitter circuitry and/or receiver circuitry that use the antenna(s) 912 of the STA 902 to facilitate signaling (e.g., the signaling 934) to and/or from the STA 902 with other devices (e.g., the AP 918).

The STA 902 may include one or more antenna(s) 912 (e.g., one, two, four, or more). For embodiments with multiple antenna(s) 912, the STA 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 902 may be accomplished according to precoding (or digital beamforming) that is applied at the STA 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In certain embodiments having multiple antennas, the STA 902 may implement analog beamforming techniques, whereby phases of the signals sent by the antenna(s) 912 are relatively adjusted such that the (joint) transmission of the antenna(s) 912 can be directed (this is sometimes referred to as beam steering).

The STA 902 may include one or more interface(s) 914. The interface(s) 914 may be used to provide input to or output from the STA 902. For example, an STA 902 that is a UE may include interface(s) 914 such as microphones, speakers, a touchscreen, buttons, and the like, to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The STA 902 may include a DPS module 916. The DPS module 916 may be implemented via hardware, software, or combinations thereof. For example, the DPS module 916 may be implemented as a processor, circuit, and/or instructions 908 stored in the memory 906 and executed by the processor(s) 904. In some examples, the DPS module 916 may be integrated within the processor(s) 904 and/or the transceiver(s) 910. For example, the DPS module 916 may be implemented by a combination of software components (e.g., executed by a DSP or a general processor) and hardware components (e.g., logic gates and circuitry) within the processor(s) 904 or the transceiver(s) 910.

The DPS module 916 may be used for various aspects of the present disclosure, for example, aspects of FIG. 1, FIG. 2, FIG. 3, FIG. 5, FIG. 6, FIG. 7, and/or FIG. 8. The DPS module 916 is configured to determine DPS operation parameters based on signaling from the AP 918

The AP 918 may include one or more processor(s) 920. The processor(s) 920 may execute instructions such that various operations of the AP 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The AP 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The AP 918 may include one or more transceiver(s) 926 that may include RF transmitter circuitry and/or receiver circuitry that use the antenna(s) 928 of the AP 918 to facilitate signaling (e.g., the signaling 934) to and/or from the AP 918 with other devices (e.g., the STA 902).

The AP 918 may include one or more antenna(s) 928 (e.g., one, two, three, four, or more). In embodiments having multiple antenna(s) 928, the AP 918 may perform MIMO, digital beamforming, analog beamforming, beam steering, etc., as has been described.

The AP 918 may include one or more interface(s) 930. The interface(s) 930 may be used to provide input to or output from the AP 918. For example, an AP 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The AP 918 may include a DPS module 932. The DPS module 932 may be implemented via hardware, software, or combinations thereof. For example, the DPS module 932 may be implemented as a processor, circuit, and/or instructions 924 stored in the memory 922 and executed by the processor(s) 920. In some examples, the DPS module 932 may be integrated within the processor(s) 920 and/or the transceiver(s) 926. For example, the DPS module 932 may be implemented by a combination of software components (e.g., executed by a DSP or a general processor) and hardware components (e.g., logic gates and circuitry) within the processor(s) 920 or the transceiver(s) 926.

The DPS module 932 may be used for various aspects of the present disclosure, for example, aspects of FIG. 1, FIG. 2, FIG. 3, FIG. 5, FIG. 6, FIG. 7, and/or FIG. 8. The DPS module 932 is configured provide the STA 902 with DPS operating parameters.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with a STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc., are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a mobile Access Point (mobile-AP), the method comprising:
generating a frame comprising dynamic power save (DPS) operating parameters;
sending the frame to one or more non-AP stations (STAs); and
enabling DPS operation according to the DPS operating parameters in the frame.

2. The method of claim 1, wherein the frame comprises a DPS operation information element (IE) comprising a DPS enabled field that indicates if DPS will be enabled, and a mode switch count target beacon transmission time (TBTT) at which a DPS state change will take effect.

3. The method of claim 1, wherein the DPS operating parameters comprise a DPS padding duration and a DPS transition delay.

4. The method of claim 1, wherein the frame with the DPS operating parameters is sent using broadcast signaling.

5. The method of claim 4, wherein the broadcast signaling comprises a beacon frame, a probe response frame, or a fast initial link setup (FILS) discovery frame.

6. The method of claim 4, further comprising setting a UHR critical update flag in a capability information field of the broadcast signaling when there is a modification of a DPS operating parameters or when a DPS operation IE is included in the broadcast signaling.

7. The method of claim 1, wherein the frame with the DPS operating parameters is sent using unicast signaling.

8. The method of claim 7, wherein the unicast signaling comprises an Association Response frame or a DPS Notification Frame.

9. A method for a non-Access Point Station (non-AP STA), the method comprising:
receiving a frame comprising dynamic power save (DPS) operating parameters, wherein the DPS operating parameters comprise a DPS padding duration;
sending, to a mobile-AP, an ICF with padding of a length based on the DPS padding duration to request that the mobile-AP transition from a lower capability mode to a higher capability mode; and
sending a Physical layer Protocol Data Unit (PPDU) to the mobile-AP while the mobile-AP is in the higher capability mode.

10. The method of claim 9, wherein the frame comprises a DPS operation information element (IE) comprising a DPS enabled field that indicates if DPS will be enabled, and a mode switch count target beacon transmission time (TBTT) at which a DPS state change will take effect.

11. The method of claim 9, wherein the DPS operating parameters further comprise a DPS transition delay.

12. The method of claim 9, wherein the frame with the DPS operating parameters is received in broadcast signaling.

13. The method of claim 12, wherein the broadcast signaling comprises a beacon frame, a probe response frame, or a fast initial link setup (FILS) discovery frame.

14. The method of claim 12, further comprising detecting a UHR critical update flag in a capability information field of the broadcast signaling indicating that there is a modification of a DPS operating parameters or that a DPS operation IE is included in the broadcast signaling.

15. The method of claim 9, wherein the frame with the DPS operating parameters is received in unicast signaling.

16. The method of claim 15, wherein the unicast signaling comprises an Association Response frame or a DPS Notification Frame.

17. A computing apparatus for a mobile Access Point (mobile-AP) comprising:
a processor; and
a memory storing instructions that, when executed by the processor, configure the apparatus to:
generate a frame comprising dynamic power save (DPS) operating parameters;
send the frame to one or more non-AP stations (STAs); and
enable DPS operation according to the DPS operating parameters in the frame.

18. The computing apparatus of claim 17, wherein the frame comprises a DPS operation information element (IE) comprising a DPS enabled field that indicates if DPS will be enabled, and a mode switch count target beacon transmission time (TBTT) at which a DPS state change will take effect.

19. The computing apparatus of claim 17, wherein the DPS operate parameters comprise a DPS padding duration and a DPS transition delay.

20. The computing apparatus of claim 17, wherein the frame with the DPS operate parameters is sent using broadcast signaling.
